(19) United States
(12) Patent Application Publication
(10) Pub. No.: US 2024/0036316 A1
(43) Pub. Date: Feb. 1, 2024

(54) HIGHLY EFFICIENT, ULTRA-FAST PBP LENS DESIGN AND FABRICATION

(71) Applicant: Meta Platforms Technologies, LLC, Menlo Park, CA (US)

(72) Inventors: Chulwoo OH, Sammamish, WA (US); Hyunmin SONG, Redmond, WA (US); Junren WANG, Kirkland, WA (US); Lu LU, Kirkland, WA (US); Sawyer MILLER, Bellevue, WA (US); Stefanie TAUSHANOFF, Woodinville, WA (US); Yun-Han LEE, Redmond, WA (US)

(21) Appl. No.: 17/874,211

(22) Filed: Jul. 26, 2022

(51) Int. Cl. G02B 27/01; G02B 5/30; G02B 27/28

(52) U.S. Cl. CPC G02B 27/0172; G02B 5/3016; G02B 27/286; G02B 2027/0178

(57) ABSTRACT

A Pancharatnam-Berry phase (PBP) lens includes a substrate and one or more liquid crystal material layers on the substrate. The one or more liquid crystal material layers include a plurality of zones at different distances from a center of the PBP lens, where different zones of the plurality of zones of the one or more liquid crystal material layers have different liquid crystal twist angles along a surface-normal direction of the substrate and different phase delays for surface-normal incident light. The PBP lens can have an f-number less than 1, and can be used in a near-eye display system to project display images to an eye of a user at an efficiency greater than 75% at a peripheral region of the PBP lens.

### BACKGROUND

An artificial reality system, such as a head-mounted display (HMD) or heads-up display (HUD) system, generally includes a near-eye display system in the form of a headset or a pair of glasses and configured to present content to a user via an electronic or optic display within, for example, about 10-20 mm in front of the user's eyes. The near-eye display system may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

A near-eye display generally includes an optical system configured to form an image of a computer-generated image on an image plane. The optical system of the near-eye display may relay the image generated by an image source (e.g., a display panel) to create a virtual image that appears to be away from the image source and further than just a few centimeters away from the user's eyes. For example, the optical system may collimate the light from the image source or otherwise convert spatial information of the displayed virtual objects into angular information to create a virtual image that may appear to be far away. The optical system may also magnify the image source to make the image appear larger than the actual size of the image source. It is generally desirable that the optical system of a near-eye display has a small size, a low weight, a large field of view, a large eye box, a high efficiency, and a low cost.

### SUMMARY

This disclosure relates generally to Pancharatnam-Berry phase (PBP) lenses for near-eye display. More specifically, and without limitation, techniques disclosed herein relate to ultra-fast PBP lenses with spatially varying liquid crystal structures for improved efficiency over a large field of view and a large area of the PBP lenses. Various inventive embodiments are described herein, including devices, systems, methods, structures, materials, processes, and the like.

According to certain embodiments, a PBP lens includes a substrate, and one or more liquid crystal material layers on the substrate and including a plurality of zones at different distances from a center of the PBP lens, where different zones of the plurality of zones of the one or more liquid crystal material layers are characterized by different liquid crystal twist angles along a surface-normal direction of the substrate. In some embodiments, the PBP lens may have an f-number less than 1.

In some embodiments of the PBP lens, a first liquid crystal twist angle of a first zone of the plurality of zones of the one or more liquid crystal material layers closer to the center of the PBP lens than a second zone of the plurality of zones of the one or more liquid crystal material layers may be smaller than a second liquid crystal twist angle of the second zone of the plurality of zones of the one or more liquid crystal material layers. In some embodiments, liquid crystal twist angles of the plurality of zones of the one or more liquid crystal material layers may decrease as distances of the plurality of zones from the center of the PBP lens increase. The different liquid crystal twist angles of the different zones of the plurality of zones of the liquid crystal material layer may be between about 0° and about 90°. Phase delays of two or more zones of the plurality of the zones of the one or more liquid crystal material layers may be different from π for surface-normal incident light.

In some embodiments of the PBP lens, the substrate may include an alignment layer with an alignment pattern formed therein, and liquid crystal molecules in the one or more liquid crystal material layers may be arranged according to the alignment pattern in a plane parallel to the substrate. In some embodiments, the different zones of the plurality of zones of the one or more liquid crystal material layers may have different material compositions, different thicknesses, or both. In some embodiments, the different material compositions may include different concentrations of a chiral dopant. In some embodiments, two or more zones of the plurality of zones of the one or more liquid crystal material layers may be formed on two or more respective substrates. In some embodiments, a pitch of a first zone of the plurality of zones of the one or more liquid crystal material layers closer to the center of the PBP lens than a second zone of the plurality of zones of the one or more liquid crystal material layers may be larger than a pitch of the second zone of the plurality of zones of the one or more liquid crystal material layers. An efficiency of the PBP lens at a peripheral region of the PBP lens may be greater than 75% for light of a visible wavelength.

According to certain embodiments, a near-eye display system includes a display panel configured to generate display images, and a PBP lens configured to project the display images to an eye of a user of the near-eye display system. The PBP lens may include a substrate, and one or more liquid crystal material layers on the substrate and including a plurality of zones at different distances from a center of the PBP lens, where different zones of the plurality of zones of the one or more liquid crystal material layers may be characterized by different liquid crystal twist angles along a surface-normal direction of the substrate.

In some embodiments of the near-eye display system, the PBP lens may be characterized by an f-number less than 1 and an efficiency at a peripheral region of the PBP lens greater than 75% for light of a visible wavelength. In some embodiments, liquid crystal twist angles of the plurality of zones of the one or more liquid crystal material layers may decrease as distances of the plurality of zones from the center of the PBP lens increase. In some embodiments, a pitch of a first zone of the plurality of zones of the one or more liquid crystal material layers closer to the center of the PBP lens than a second zone of the plurality of zones of the one or more liquid crystal material layers may be larger than a pitch of the second zone of the plurality of zones of the one or more liquid crystal material layers.

In some embodiments of the near-eye display system, the substrate may include an alignment layer with an alignment pattern formed therein, and liquid crystal molecules in the one or more liquid crystal material layers may be arranged according to the alignment pattern in a plane parallel to the substrate. In some embodiments, the different zones of the plurality of zones of the one or more liquid crystal material layers may be characterized by different material compositions that include different concentrations of a chiral dopant. In some embodiments, the plurality of zones of the one or more liquid crystal material layers may be formed on two or more substrates. In some embodiments, the near-eye display system may include a circular polarizer between the display panel and the PBP lens.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 is a cross-sectional view of an example of a near-eye display according to certain embodiments.

FIG. 5 illustrates an example of an optical system with a non-pupil forming configuration for a near-eye display device according to certain embodiments.

FIG. 6 illustrates an example of an optical see-through augmented reality system including a waveguide display according to certain embodiments.

FIG. 7A is a view of an x-z plane of an example of a PBP grating.

FIG. 7B is a view of an x-y plane of the example of PBP grating shown in FIG. 7A.

FIG. 8A illustrates LC molecule orientations in an example of a PBP lens according to certain embodiments.

FIG. 8B illustrates the LC molecule orientations of a portion of the PBP lens of FIG. 8A according to certain embodiments.

FIGS. 9A and 9B illustrate an example of a PBP lens that is sensitive to circularly polarized light according to certain embodiments.

FIG. 10A illustrates the diffraction efficiency of an example of a PBP lens as a function of the phase delay.

FIG. 10B illustrates the diffraction of light from different fields of view by an example of a PBP lens with uniform liquid crystal coating.

FIG. 10C includes an example of the diffraction efficiency of a PBP lens including liquid crystals with uniform liquid crystal coating.

FIG. 11A illustrates the diffraction of light from different fields of view (or incident angle) by a PBP lens having a uniform liquid crystal coating.

FIG. 11B illustrates the performance of an example of a PBP lens including liquid crystals with a uniform twist angle (e.g., about 0°) as a function of the location on the PBP lens.

FIG. 12 illustrates an example of a PBP lens including liquid crystals with spatially varying twist angles based on the angle of interest (e.g., view angle) according to certain embodiments.

FIG. 13A illustrates an example of a PBP lens including liquid crystals with spatially varying twist angles according to certain embodiments.

FIG. 13B illustrates the performance of an example of a PBP lens including liquid crystals with spatially varying twist angles according to certain embodiments.

FIG. 13C illustrates an example of a PBP lens including liquid crystals with spatially varying twist angles according to certain embodiments.

FIG. 13D illustrates the LC twist angles at different positions (zones) of the PBP lens of FIG. 13C according to certain embodiments.

FIG. 14A is a side view of an example of a PBP lens including liquid crystals with spatially varying twist angles according to certain embodiments.

FIG. 14B is a top view of the example of the PBP lens of FIG. 14A.

FIG. 14C illustrates an example of the LC twist angle variations at different positions of the PBP lens of FIG. 14A according to certain embodiments.

FIG. 15A illustrates an example of a method of fabricating a PBP lens with spatially varying LC twist angles according to certain embodiments.

FIG. 15B illustrates another example of a method of fabricating a PBP lens with spatially varying LC twist angles according to certain embodiments.

FIG. 15C illustrates another example of a relationship between the LC twist angle and the UV light exposure dose for fabricating a PBP lens with spatially varying LC twist angles according to the method of FIG. 15B.

FIG. 16A illustrates another example of a method of fabricating a PBP lens with spatially varying LC twist angles according to certain embodiments.

FIG. 16B illustrates yet another example of a method of fabricating a PBP lens with spatially varying LC twist angles according to certain embodiments.

FIG. 17 illustrates an example of a method of fabricating a PBP lens with spatially varying LC twist angles using nano-imprinting techniques according to certain embodiments.

FIG. 18A includes a flowchart illustrating an example of a process of fabricating a PBP lens with spatially varying LC structures according to certain embodiments.

FIG. 18B includes a flowchart illustrating another example of a process of fabricating a PBP lens with spatially varying LC structures according to certain embodiments.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to Pancharatnam-Berry phase (PBP) lenses. More specifically, and without limitation, techniques disclosed herein relate to ultra-fast PBP lenses with spatially varying liquid crystal structures for improved efficiency over a large field of view and a large area of the PBP lenses. Various inventive embodiments are described herein, including devices, systems, methods, structures, materials, processes, and the like.

Augmented reality (AR) and virtual reality (VR) applications may use near-eye displays (e.g., head-mounted displays) to present images to users. In some near-eye display systems, polarization diffraction lenses (e.g., PBP lenses) may be used to project the displayed images to user's eyes. The polarization diffraction lens may diffract light of a first polarization state (e.g., RHCP or LHCP) by a diffraction angle into a first (e.g., +1) diffraction order, and may diffract light of a second polarization state (e.g., LHCP or RHCP) by a different diffraction angle into another (e.g., −1) diffraction order. Thus, the polarization diffraction lens may have different optical powers for light of different polarization states, and may, for example, collimate or focus light in a first circular polarization state while diverging light in a second circular polarization state. The polarization diffraction lens can be made using birefringent materials such as liquid crystal (LC) polymer layers, and can be made flat. The polarization diffraction lenses may be fabricated, for example, by coating liquid crystal polymer materials on an alignment layer with alignment patterns formed thereon. The alignment patterns may include alignment patterns for a lens, and may be formed by, for example, polarization interference patterning, direct laser writing patterning, or imprint lithography. The liquid crystal polymer materials may be coated on the patterned surface of the alignment layer, for example, layer by layer, until a desired thickness and/or twist angle is reached. A curing (e.g., UV or thermal curing) process may be performed to cure the liquid crystal polymer materials and fix the twist pattern of the liquid crystal molecules.

PBP lenses can be flat and can have large apertures (small f-numbers), low weights, and high efficiencies, and thus are suitable for use in near-eye display systems to project images to user's eyes. PBP lenses generally have uniform designs (e.g., phase delays or twist angles along the beam propagation direction) that are optimized for incident light with small incident angles (e.g., surface-normal incident light or paraxial light) across the apertures of the lenses. Due to small angular bandwidths of PBP lenses (e.g., limited by the structures and material properties, such as the limited birefringence of the LC materials used), PBP lenses may have lower performance (e.g., low efficiency and high polarization leakage) for incident light with large incident angles (e.g., light from a large field of view). Therefore, for fast PBP lenses that have large apertures and/or short focal lengths (and thus large fields of view or large angles of incidence at a large portion of the lens aperture), the efficiencies of the PBP lenses may be low.

According to certain embodiments, to improve the performance of a PBP lens (e.g., an ultra-fast PBP lens) for larger fields of view and/or off-axis incidence, the PBP lens may be made to have spatially variable PBP structures that may vary according to the angles of interest (AOIs) at different zones or positions of the aperture of the PBP lens. For example, the PBP lens may have spatially variable LC twist angles (and/or thicknesses) across its aperture, where the LC twist angle at a position of the PBP device can be selected to optimize the diffraction efficiency for incident light from an AOI at the position. The spatially variable LC twist angles may be achieved using various fabrication techniques.

In some embodiments, the spatially variable twist angles may be achieved by depositing different mixtures of a chiral LC material and a non-chiral LC material (or another chiral LC material with a different twisting power) at different zones, such that the materials at different zones may have different twisting power. In some embodiments, the spatially variable twist angles may be achieved by curing a LC material layer using gradient or gray-scale UV light to promote different diffusion of the chiral agents into different regions of the LC material layer. In some embodiments, the spatially variable twisting angles may be achieved by performing multiple cycles of uniform LC material layer deposition, UV curing, and lithographic patterning to effectively achieve different materials, different exposure doses, and/or different material thicknesses at different zones of a PBP lens. In some embodiments, the spatially variable twist angles may be achieved by fabricating multiple patterned layers of LC materials and stacking the multiple patterned layers together. In some embodiments, the spatially variable twist angles may be achieved by depositing (e.g., inkjet printing) different LC materials on different regions of a bare substrate, imprinting the LC materials using a nanoimprinting mold or stamp with designed patterns, and curing the LC materials.

The PBP lenses described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

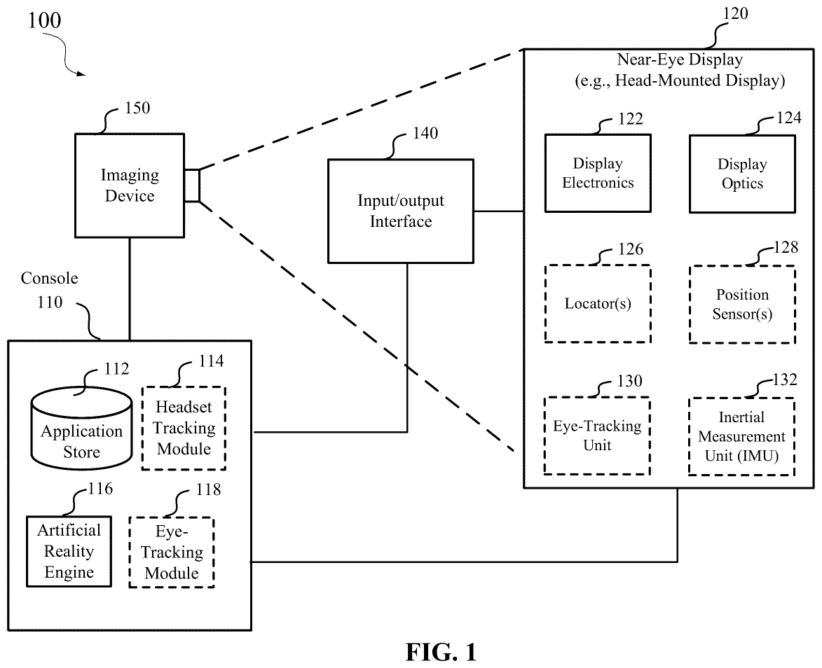

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

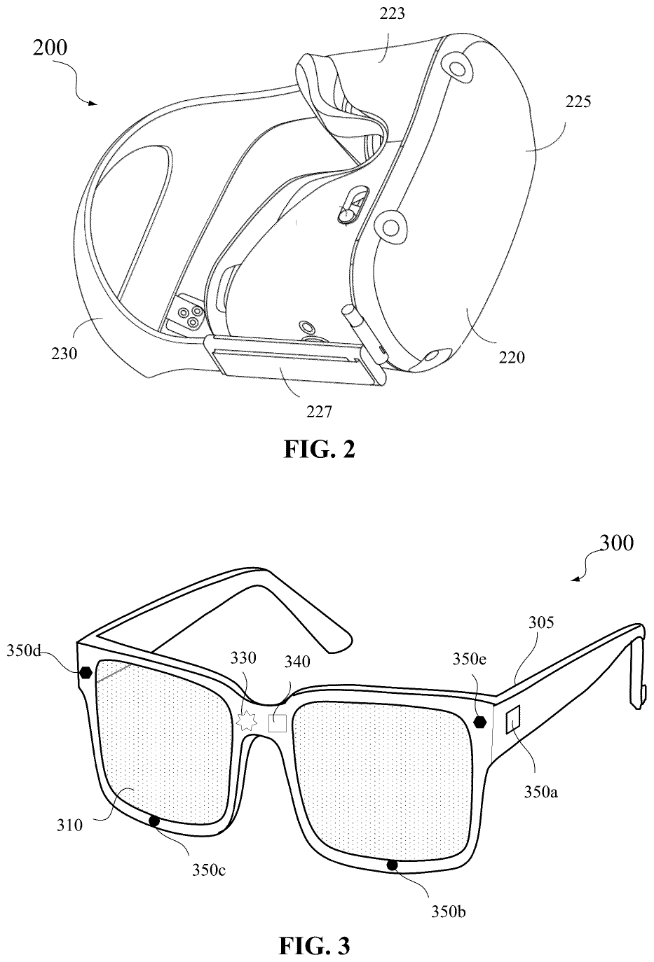

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to determine the eye's orientation more accurately.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

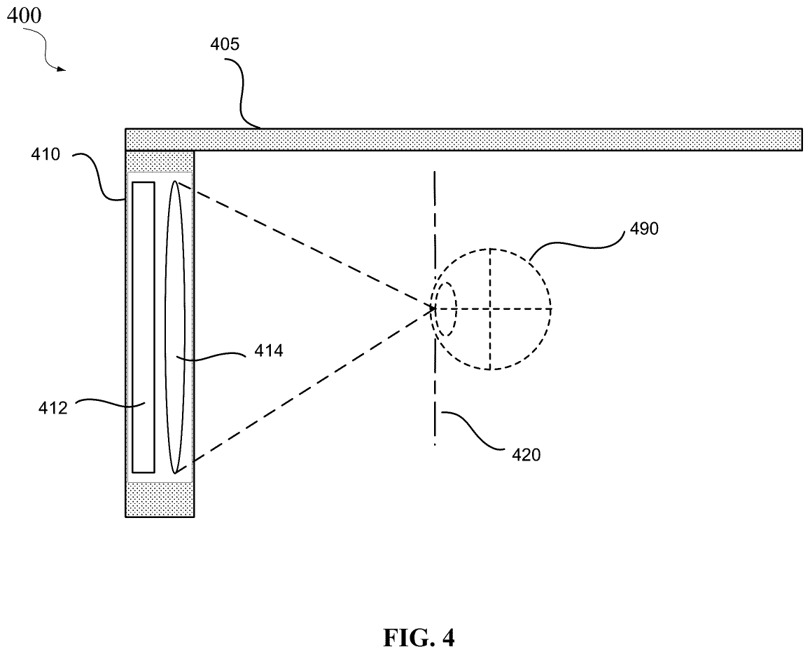

FIG. 4 is a cross-sectional view of an example of a near-eye display 400 according to certain embodiments. Near-eye display 400 may include at least one display assembly 410. Display assembly 410 may be configured to direct image light (e.g., display light) to an eyebox located at an exit pupil 420 and to user's eye 490. It is noted that, even though FIG. 4 and other figures in the present disclosure show an eye of a user of the near-eye display for illustration purposes, the eye of the user is not a part of the corresponding near-eye display.

As HMD device 200 and near-eye display 300, near-eye display 400 may include a frame 405 and display assembly 410 that may include a display 412 and/or display optics 414 coupled to or embedded in frame 405. As described above, display 412 may display images to the user electrically (e.g., using LCDs, LEDs, OLEDs) or optically (e.g., using a waveguide display and optical couplers) according to data received from a processing unit, such as console 110. In some embodiments, display 412 may include a display panel that includes pixels made of LCDs, LEDs, OLEDs, and the like. Display 412 may include sub-pixels to emit light of a predominant color, such as red, green, blue, white, or yellow. In some embodiments, display assembly 410 may include a stack of one or more waveguide displays including, but not restricted to, a stacked waveguide display, a varifocal waveguide display, and the like. The stacked waveguide display may be a polychromatic display (e.g., a red-green-blue (RGB) display) created by stacking waveguide displays whose respective monochromatic sources are of different colors.

Display optics 414 may be similar to display optics 124 and may display image content optically (e.g., using optical waveguides and optical couplers), correct optical errors associated with the image light, combine images of virtual objects and real objects, and present the corrected image light to exit pupil 420 of near-eye display 400, where the user's eye 490 may be located. In some embodiments, display optics 414 may also relay the images to create virtual images that appear to be away from display 412 and further than just a few centimeters away from the eyes of the user. For example, display optics 414 may collimate the image source to create a virtual image that may appear to be far away (e.g., greater than about 0.3 m, such as about 0.5 m, 1 m, or 3 m away) and convert spatial information of the displayed virtual objects into angular information. In some embodiments, display optics 414 may also magnify the source image to make the image appear larger than the actual size of the source image. More details of display 412 and display optics 414 are described below.

In various implementations, the optical system of a near-eye display, such as an HMD, may be pupil-forming or non-pupil-forming. Non-pupil-forming HMDs may not use intermediary optics to relay the displayed image, and thus the user's pupils may serve as the pupils of the HMD. Such non-pupil-forming displays may be variations of a magnifier (sometimes referred to as “simple eyepiece”), which may magnify a displayed image to form a virtual image at a greater distance from the eye. The non-pupil-forming display may use fewer optical elements. Pupil-forming HMDs may use optics similar to, for example, optics of a compound microscope or telescope, and may include some forms of projection optics that magnify an image and relay it to the exit pupil.

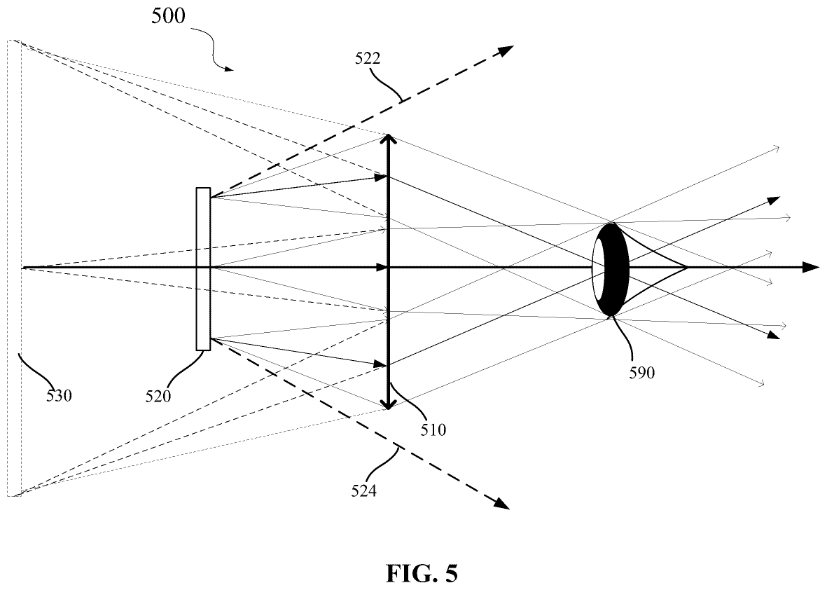

FIG. 5 illustrates an example of an optical system 500 with a non-pupil forming configuration for a near-eye display device according to certain embodiments. Optical system 500 may be an example of near-eye display 400, and may include display optics 510 and an image source 520 (e.g., a display panel). Display optics 510 may function as a magnifier. FIG. 5 shows that image source 520 is in front of display optics 510. In some other embodiments, image source 520 may be located outside of the field of view of the user's eye 590. For example, one or more deflectors or directional couplers may be used to deflect light from an image source to make the image source appear to be at the location of image source 520 shown in FIG. 5. Image source 520 may be an example of display 412 described above. For example, image source 520 may include a two-dimensional array of light emitters, such as semiconductor micro-LEDs or micro-OLEDs. The dimensions and pitches of the light emitters in image source 520 may be small. For example, each light emitter may have a diameter less than 2 μm (e.g., about 1.2 μm) and the pitch may be less than 2 μm (e.g., about 1.5 μm). As such, the number of light emitters in image source 520 can be equal to or greater than the number of pixels in a display image, such as 960×720, 1280×720, 1440×1080, 1920×1080, 2160×1080, or 2560×1080 pixels. Thus, a display image may be generated simultaneously by image source 520.

Light from an area (e.g., a pixel or a light emitter) of image source 520 may be directed to a user's eye 590 by display optics 510. Light directed by display optics 510 may form virtual images on an image plane 530. The location of image plane 530 may be determined based on the location of image source 520 and the focal length of display optics 510. A user's eye 590 may form a real image on the retina of user's eye 590 using light directed by display optics 510. In this way, objects at different spatial locations on image source 520 may appear to be objects on an image plane far away from user's eye 590 at different viewing angles. Image source 520 may have a size larger or smaller than the size (e.g., aperture) of display optics 510. Some light emitted from image source 520 with large emission angles (as shown by light rays 522 and 524) may not be collected and directed to user's eye 590 by display optics 510, and may become stray light.

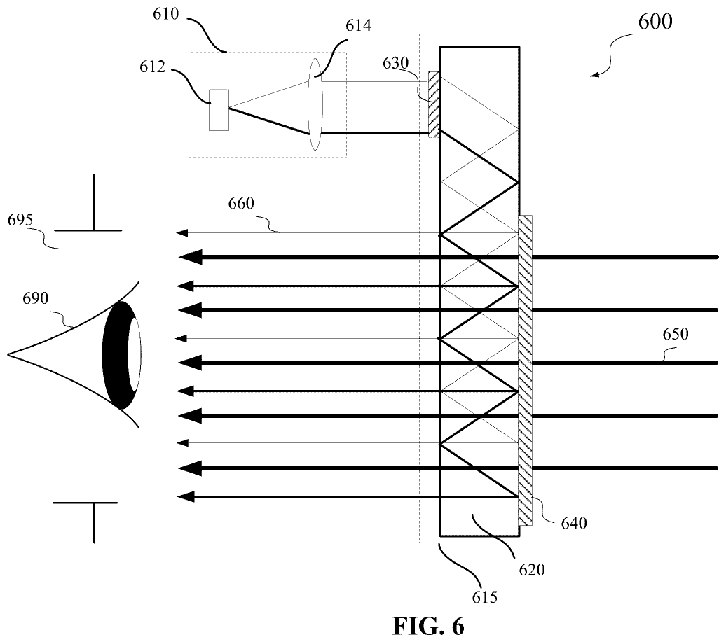

FIG. 6 illustrates an example of an optical see-through augmented reality system 600 including a waveguide display according to certain embodiments. Augmented reality system 600 may be another example of near-eye display 400, and may include a projector 610 and a combiner 615. Projector 610 may include a light source or image source 612 and projector optics 614. In some embodiments, image source 612 may include a plurality of pixels that displays virtual objects, such as an LCD display panel or an LED display panel. For example, in some embodiments, light source or image source 612 may include one or more micro-LED devices, such as micro-OLED devices or semiconductor micro-LED devices. In some embodiments, image source 612 may include a plurality of light sources (e.g., a two-dimensional array of micro-LEDs), each emitting a monochromatic image light corresponding to a primary color (e.g., red, green, or blue). In some embodiments, image source 612 may include three two-dimensional arrays of micro-LEDs, where each two-dimensional array of micro-LEDs may include micro-LEDs configured to emit light of a primary color (e.g., red, green, or blue). In some embodiments, image source 612 may include a coherent or partially coherent light source (e.g., a laser) and an optical pattern generator, such as a spatial light modulator.

Projector optics 614 may include one or more optical components that can condition the light from image source 612, such as expanding, collimating, scanning, or projecting light from image source 612 to combiner 615. The one or more optical components may include, for example, one or more solid lenses, liquid lenses, mirrors, apertures, and/or gratings. In some embodiments, image source 612 may include one or more two-dimensional arrays of micro-LEDs, and projector optics 614 may include a lens assembly. In some embodiments, image source 612 may include one or more one-dimensional arrays or elongated two-dimensional arrays of micro-LEDs, and projector optics 614 may include one or more one-dimensional scanners (e.g., micro-mirrors or prisms) configured to scan light emitted by the one-dimensional arrays or elongated two-dimensional arrays of micro-LEDs to generate image frames. In some embodiments, projector optics 614 may include a liquid lens (e.g., a liquid crystal lens) with a plurality of electrodes that allows scanning of light from image source 612.

Combiner 615 may include an input coupler 630 for coupling light from projector 610 into a substrate 620 of combiner 615. Input coupler 630 may include, for example, a diffractive optical element (DOE) (e.g., a volume holographic grating, a surface-relief grating, a PBP grating, or a PVH grating), a slanted surface of substrate 620, or a refractive coupler (e.g., a wedge or a prism). For example, input coupler 630 may include a transmissive volume Bragg grating (e.g., on a surface of substrate 620 facing projector 610) or a reflective volume Bragg grating (e.g., on a surface of substrate 620 opposing projector 610). Input coupler 630 may have a coupling efficiency of greater than 30%, 50%, 75%, 90%, or higher for visible light. Light coupled into substrate 620 may propagate within substrate 620 through, for example, total internal reflection (TIR). In some embodiments, substrate 620 may be in the form of a lens of a pair of eyeglasses. Substrate 620 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 620 may be transparent to visible light.

Substrate 620 may include or may be coupled to a plurality of output couplers 640. Each output coupler 640 may be configured to extract at least a portion of the light guided by and propagating within substrate 620 out of substrate 620, and direct the extracted light 660 towards an eyebox 695 where an eye 690 of the user of augmented reality system 600 may be located when augmented reality system 600 is in use. The plurality of output couplers 640 may replicate the exit pupil to increase the size of eyebox 695 such that the displayed image may be visible in a larger area. As input coupler 630, output couplers 640 may include grating couplers (e.g., volume holographic gratings or surface-relief gratings), other diffraction optical elements (DOEs), prisms, partial reflectors (e.g., transflective mirrors), and the like. For example, output couplers 640 may include reflective volume Bragg gratings, transmissive volume Bragg gratings, or PVHs. Output couplers 640 may have different coupling (e.g., diffraction) efficiencies at different locations such that the intensities of the light beams coupled out of substrate 620 at different locations may be about the same. Substrate 620 and output couplers 640 may also allow light 650 from the environment in front of combiner 615 to pass through with little or no loss. For example, in some implementations, output couplers 640 may have a very low diffraction efficiency for light 650 such that light 650 may be refracted or otherwise pass through output couplers 640 with little loss, and may have a higher intensity than extracted light 660. As a result, the user may be able to view combined images of the environment in front of combiner 615 and images of virtual objects projected by projector 610.

In some near-eye display systems, polarization diffraction lenses, such as PBP lenses, may be used to project the displayed images to user's eyes. The polarization diffraction lens may diffract light of a first polarization state (e.g., RHCP or LHCP) by a certain diffraction angle and at a certain diffraction efficiency into a first (e.g., +1) diffraction order, and may diffract light of a second polarization state (e.g., LHCP or RHCP) by a different diffraction angle and at a certain diffraction efficiency into another (e.g., −1) diffraction order. Thus, the polarization diffraction lens may have different optical powers for light of different polarization states, and may, for example, collimate or focus light in a first circular polarization state while diverging light in a second circular polarization state. The polarization diffraction lens can be made using birefringent materials such as liquid crystal (LC) polymer layers, and can be made flat. The polarization diffraction lenses may be fabricated, for example, by coating liquid crystal polymer materials on an alignment layer with alignment patterns formed thereon. The alignment patterns may include alignment patterns for a lens, and may be formed by, for example, polarization interference patterning, direct laser writing patterning, or imprint lithography. The liquid crystal polymer materials may be coated on the patterned surface of the alignment layer, for example, layer by layer, until a desired thickness and/or twist angle is reached. A curing (e.g., UV or thermal curing) process may be performed to cure the liquid crystal polymer materials and fix the twist pattern of the liquid crystal molecules.

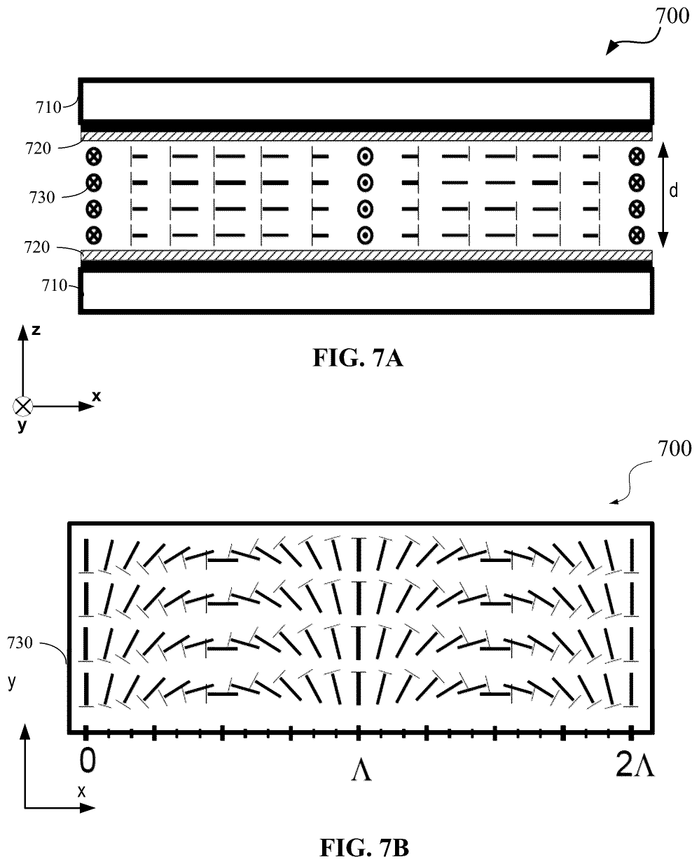

FIG. 7A is a view of an x-z plane of an example of a PBP grating 700. FIG. 7B is a view of an x-y plane of the example of PBP grating 700 shown in FIG. 7A. In the illustrated example, PBP grating 700 may include a pair of substrates 710, one or two surface alignment layers 720, and a liquid crystal layer 730. Substrates 710 may be transparent to visible light. Surface alignment layer(s) 720 may have a predefined surface pattern, such that liquid crystal molecules in liquid crystal layer 730 may self-align according to the predefined surface pattern. The surface pattern of the alignment layer may be formed by, for example, photo-alignment, micro-rubbing, non-uniform surface polymerization combined with rubbing, creation of surface polymer network, and the like. In some embodiments, PBP grating 700 may include one substrate and a cured film attached to the substrate, or may include a freestanding film that does not need to be attached to a substrate.

As illustrated, liquid crystal layer 730 in PBP grating 700 may include liquid crystal molecules that are oriented in a repetitive rotational pattern in the x-y plane when viewed in the light propagation direction (e.g., z direction). The repetitive rotational pattern may be created by, for example, recording the interference pattern of two orthogonally circular-polarized laser beams in a polarization-sensitive photo-alignment material in surface alignment layer 720. Due to the repetitive rotational pattern of liquid crystal molecules in an x-y plane of liquid crystal layer 730, PBP grating 700 may have an in-plane, uniaxial birefringence that varies with position. The liquid crystal structure having the repetitive rotational pattern may give rise to a geometric-phase shift of incident light due to the polarization evolution as the light propagates through liquid crystal layer 730 along the z direction. In the example shown in FIG. 7A, the liquid crystal molecules in liquid crystal layer 730 may not be twisted along the z direction (e.g., with twist angle about 0° along the z direction) at any x-y location. In some embodiments, the liquid crystal molecules in liquid crystal layer 730 may be twisted along the z direction to form helical structures, and the twist angle along the z direction may be about the same at different x-y locations.

The diffraction efficiency of PBP grating 700 for surface-normal incident light (e.g., light propagating in the z direction) may be approximately determined by:

$${η}_{0} = {cos}^{2} ( \frac{π Δ nd}{λ} ) , and \\ {η}_{\pm 1} = \frac{1 ∓ {S}_{3}^{′}}{2} {sin}^{2} ( \frac{π Δ nd}{λ} ) ,$$

where ηₘ is the diffraction efficiency of the mth diffraction order, Δn is the birefringence of liquid crystal layer 730, d is the thickness of liquid crystal layer 730, A is the wavelength of the incident light, and S′₃=S₃/S₀ is the normalized Stokes parameter corresponding to the ellipticity of the polarization of the incident light. As indicated by the above equations, if the grating thickness d=λ/(2Δn) in the z direction (i.e., a half-wave retardation by liquid crystal layer 730), the zeroth order transmission η₀ may be zero, and all incident light may be diffracted to the ±1 diffraction orders. The zeroth diffraction order may be polarization independent, while the ±1 diffraction orders may be sensitive to S′₃. For example, when the grating thickness d=λ/2Δn and the incident light has a right-handed circular polarization (S′₃=+1), η₊₁=0 and η₋₁=1, which indicates that all incident light passing through PBP grating 700 may be diffracted into the −1 diffraction order. When the grating thickness d=λ/2Δn and the incident light has a left-handed circular polarization (S′₃=−1), η₊₁=1 and η₋₁=0, which indicates that all incident light is diffracted into the +1 diffraction order. Although m=+1 diffraction order is herein considered as the primary order and the m=−1 diffraction order is considered the conjugate order, the designation of the orders may be reversed or otherwise changed. In general, only the zeroth and the two first diffracted orders may be possible, regardless of the grating period A and the thickness d.

Moreover, after passing through PBP grating 700, the circularly polarized light may be changed to light of the opposite circular polarization state, because the light may experience a relative phase shift about a half wavelength in liquid crystal layer 730. For example, after the right-handed circularly polarized light (S₃=1) passes through PBP grating 700, the polarization state of the light (e.g., in the −1 diffraction order) may be changed to the left-handed circular polarization (S₃=−1). After the left-handed circularly polarized light (S₃=−1) passes through PBP grating 700, the polarization state of the light (e.g., in the +1 diffraction order) may be changed to the right-handed circular polarization (S₃=1).

The pitch Λ (or period) of the repetitive rotational pattern of the liquid crystal molecules in an x-y plane of PBP grating 700 may determine, in part, certain optical properties of PBP grating 700. For example, the pitch Λ may determine the diffraction angles of the different diffraction orders according to the grating equation. Generally, the smaller the pitch, the larger the diffraction angle for light of a given wavelength and a given diffraction order.

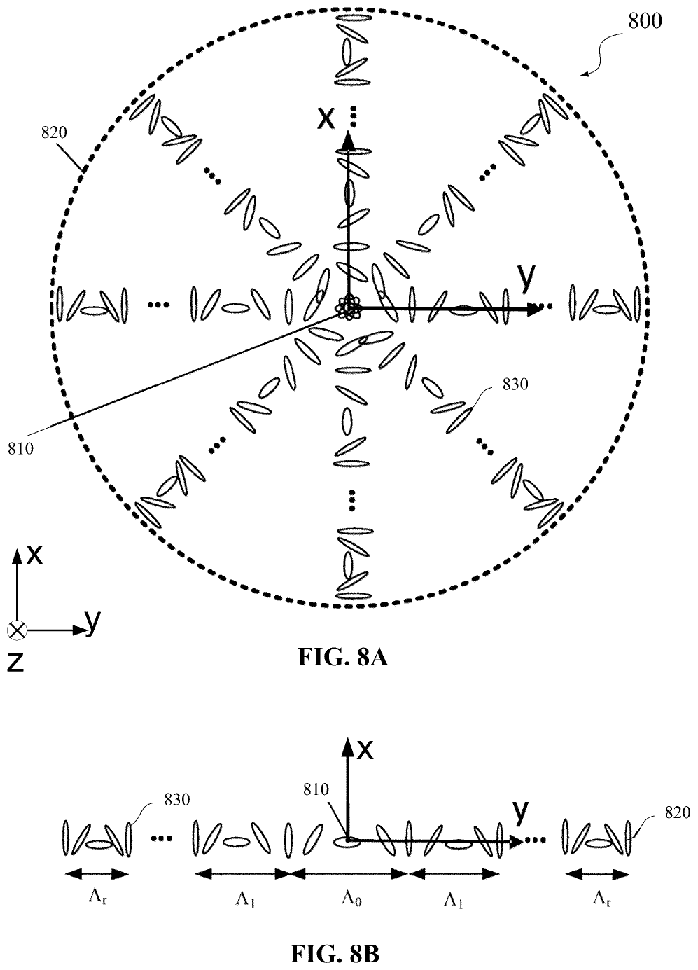

FIG. 8A illustrates LC molecule orientations in an example of a PBP lens 800 according to certain embodiments. FIG. 8B illustrates the LC molecule orientations of a portion of PBP lens 800 according to certain embodiments. PBP lens 800 may focus or diverge light due to the gradient of geometric phase within the lens. As shown in FIG. 8A, PBP lens 800 may have a phase profile of a lens created by LC molecules 830 with different in-plane orientations, where the phase delay φ(r) at a location may be a function of the azimuth angle ψ(r) of the optical axis (e.g., orientations of LC molecules 830) at the location: φ(r)=±2ψ(r). The azimuth angles ψ(r) of LC molecules 830 may be continuously changed from a center 810 to an edge 820 of PBP lens 800. The pitch Λ of the rotational pattern of liquid crystal molecules 830 within which the azimuth angles of LC molecules 830 are rotated by 180° may vary from center 810 to edge 820 of PBP lens 800 to vary the diffraction angle. Accordingly, PBP lens 800 can have a large aperture size and can be made with a thin LC layer to cause a half-wave retardation. PBP lens 800 may have a twisted or non-twisted structure along the z-axis. A dual twist or multiple twisted structure along the z-axis may offer achromatic performance in PBP lens 800. A non-twisted structure along the z-axis may be easier to fabricate than a twisted structure, but may not offer achromatic performance.

The portion of PBP lens 800 shown in FIG. 8B may be taken along a radial direction, such as along the y-axis. As shown in FIG. 8B, the pitch Λ of the rotational pattern of liquid crystal molecules 830 may be a function of the distance from center 810 and may progressively decrease as the distance from center 810 increases. For example, the pitch Λ₀ at center 810 may be the longest, the pitch Λᵣ at edge 820 may be the shortest, and the pitch Λₙ between center 810 and edge 820 may be between pitch Λ₀ and pitch Λᵣ. Therefore, light incident on the center region of PBP lens 800 may be diffracted by a smaller diffraction angle due to a longer pitch, while light incident on the edge region of PBP lens 800 may be diffracted by a larger diffraction angle due to a shorter pitch.

The Jones vectors of LHCP light and RHCP light can be described as:

$${J}_{\pm } = \frac{1}{\sqrt{2}} [ \begin{matrix}1 \\ \pm j\end{matrix} ] ,$$

where J₊ and J₋ represent the Jones vectors of LHCP light and RHCP light, respectively. For a PBP lens with focal length f, the local azimuthal angle ψ(r) in an x-y plane may vary according to:

$$\pm 2 ψ ( r ) = φ ( r ) = - \frac{ω}{c} ( \sqrt{{r}^{2} + {f}^{2}} - f )$$

in order to achieve a centrosymmetric parabolic phase distribution, where φ, ω, c, and r are the relative phase, angular frequency, speed of light in vacuum, and radial coordinate of the lens, respectively. After passing through the PBP lens, the Jones vectors may be changed to:

$$\begin{matrix}{J}_{\pm }^{′} = R ( - ψ ) W ( π ) R ( ψ ) {J}_{\pm } \\ = [ \begin{matrix}cos ψ & - sin ψ \\ sin ψ & cos ψ\end{matrix} ] [ \begin{matrix}{e}^{- j \frac{π}{2}} & 0 \\ 0 & {e}^{- j \frac{π}{2}}\end{matrix} ] [ \begin{matrix}cos ψ & sin ψ \\ - sin ψ & cos ψ\end{matrix} ] \frac{1}{\sqrt{2}} [ \begin{matrix}1 \\ \pm j\end{matrix} ] \\ = \frac{- {je}^{\pm 2 j ψ}}{\sqrt{2}} [ \begin{matrix}1 \\ ∓ j\end{matrix} ] = - {je}^{\pm 2 j ψ} {J}_{∓}\end{matrix} ,$$

where R(ψ) and W(π) are the rotation matrix and the retardation Jones matrix, respectively. As can be seen from the equation above, the handedness of the output light is switched relative to the incident light. In addition, a spatial-varying phase depending on the local azimuthal angle ψ(r) is accumulated. Furthermore, the phase accumulation has opposite signs for RHCP light and LHCP light, and thus the PBP lens may modify the wavefront of RHCP and LHCP incident light differently. For example, a PBP lens may have a positive optical power for RHCP light and a negative optical power for LHCP light, or vice versa.

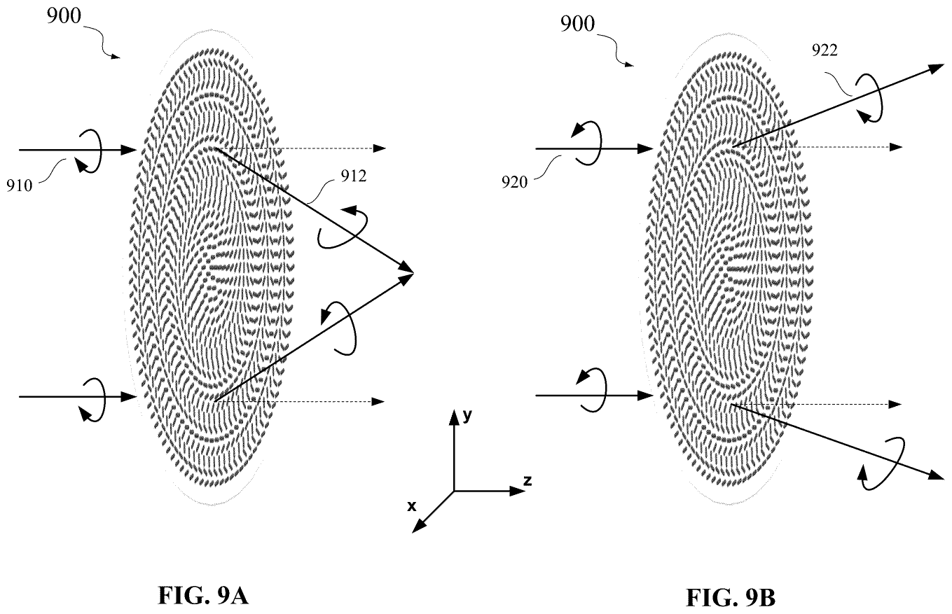

FIGS. 9A and 9B illustrate an example of a PBP lens 900 that is sensitive to circularly polarized light according to certain embodiments. PBP lens 900 may be an example of PBP lens 800. FIGS. 9A and 9B show the LC molecule orientation of PBP lens 900 in the x-y plane. The thickness d of PBP lens 900 may be selected to achieve a half-wave retardation according to d=λ/(2Δn) as described above. PBP lens 900 can be a passive or active lens, and can have a positive or negative optical power for RHCP or LHCP light in various embodiments. In the illustrated example, PBP lens 900 may have a positive optical power for RHCP light and thus may focus collimated RHCP light 910 as shown in FIG. 9A. As described above, the handedness of the output light 912 may be switched relative to the incident collimated RHCP light 910 and thus may become LHCP light. As shown in FIG. 9B, PBP lens 900 may have a negative optical power for LHCP light, and thus may diverge collimated RHCP light 920. The handedness of the output light 922 may become RHCP. When the half-wave retardation is not achieved, some input light may not be converted to the orthogonal polarization state and may not be diffracted as shown by the dashed lines in FIGS. 9A and 9B.

As described above, PBP lenses may be fabricated by coating liquid crystal polymer materials on an alignment layer with alignment patterns formed thereon. The alignment patterns may include alignment patterns for a lens, and may be formed by, for example, polarization interference patterning, direct laser writing patterning, imprint lithography, and the like. The liquid crystal polymer materials may be coated on the patterned surface of the alignment layer, for example, layer by layer, until a desired thickness is reached. A curing (e.g., UV or thermal curing) process may be performed to cure the liquid crystal polymer layers and fix the twist pattern of the liquid crystal molecules.

In one example, a photoalignment material (e.g., including a photocurable monomer material) may be coated on the surface of a substrate using, for example, spin coating or spray coating, to form a photoalignment material layer. The photoalignment material may include, for example, brilliant yellow (BY) dissolved in dimethylformamide (DMF). After the coating, the photoalignment material layer may be dried by, for example, baking at an elevated temperature (e.g., greater than about 100° C.) to remove the solvent. The photoalignment material layer may have a thickness about, for example, 10 nm to 50 nm. In one example, the photoalignment material layer may be exposed to an interference pattern generated by two overlapping circularly polarized light beams to form an alignment layer on the substrate. The circularly polarized light beams may include a left-handed circularly polarized beam and a right-handed circularly polarized beam, and may be incident on a same area of the photoalignment material layer at desired incident angles to generate a desired polarization interference pattern and record the polarization interference pattern in the photoalignment material layer. The incident angles of the two circularly polarized beams may be selected to achieve the desired pattern in the alignment layer. The exposure of the photoalignment material layer to the interference pattern may cause the polymerization of the photocurable monomers of the photoalignment material at the bright regions of the interference pattern to form polymerized chains. Thus, the orientation of the alignment pattern in the alignment layer may vary across the alignment layer according to the interference pattern.

A layer of a birefringent material may be deposited on the alignment layer, for example, by spin coating or spray coating. The birefringent material may include optically anisotropic molecules (e.g., liquid crystal molecules) and a curable stabilizing material (e.g., photocurable monomers or polymers). For example, the birefringent material may include liquid crystal molecules mixed with photocurable monomers or polymers to form polymerizable liquid crystal reactive mesogens (RMs), such as polymer-stabilized nematic liquid crystals or polymer-dispersed nematic liquid crystals. The birefringent material may have a birefringence greater than about 0.1, greater than about 0.15, greater than about 0.2, or larger. In some embodiments, the birefringent material may also include a photo-initiator, a chiral dopant, and/or a dichroic dye. The optically anisotropic molecules in the layer of the birefringent material deposited on the alignment layer may align with the alignment pattern in the alignment layer. In some embodiments, the optically anisotropic molecules in the layer of the birefringent material may form helical structures. The layer of the birefringent material may be cured to fix the curable stabilizing material, which may stabilize the liquid crystal molecules in the layer of the birefringent material. In one example, the curing may be performed by exposing the layer of the birefringent material using an ultraviolet (UV) light beam to polymerize the photocurable monomers or cross-link the polymers to form crosslinked polymers. The layer of the birefringent material with the optically anisotropic molecules stabilized or fixed by the crosslinked polymers may from a polarization diffraction lens. In some embodiments, multiple liquid crystal reactive mesogen layers may be coated layer by layer on the alignment layer, until a desired thickness (e.g., to achieve a half-wave retardation for high efficiency) is reached. The multiple liquid crystal reactive mesogen layers may be cured together or layer by layer using UV light beam.

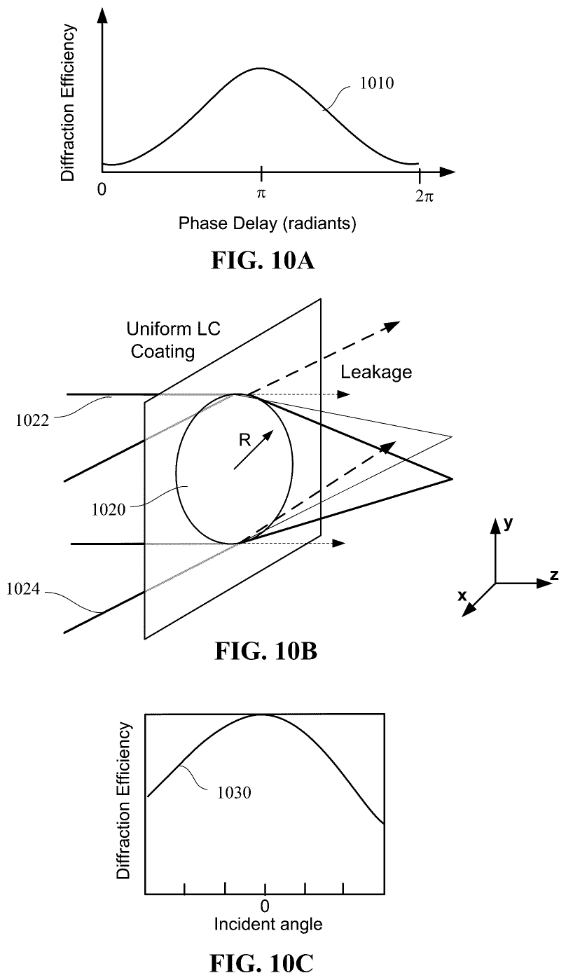

FIG. 10A includes a curve 1010 illustrating the diffraction efficiency of an example of a PBP lens as a function of the phase delay. As described above, when the PBP lens (e.g., the thickness of the PBP lens) is designed to achieve a half-wave retardation (a phase delay about π) for an incident light beam that is polarized (e.g., circularly polarized light with a certain handedness), the PBP lens may achieve the highest diffraction efficiency and may convert the incident light beam into an opposite polarization state (a circularly polarized beam with an opposite handedness). As the phase delay of the PBP lens deviates from 7r, the diffraction efficiency may decrease. It is noted that curve 1010 is for illustration purposes only, and may not necessarily represent the diffraction efficiency of all PBP lenses as a function of the phase delay.

The phase delay of an incident light beam by a PBP lens may depend on the incident angle of the incident light beam. For example, a PBP lens that may provide a half-wave birefringence for paraxial light may provide an added birefringent term for off-axis light. The added birefringent term may depend on the incident angle, and may change the phase delay for off-axis incident light, and thus may detrimentally affect the performance of a PBP lens that is designed to maximize paraxial incident light, in particular, for light with large incident angles or from wider fields of view. For a fast PBP lens with a large aperture D and a short focal length f (corresponding to a small f-number, such as less than about 2, less than about 1, or less than about 0.5), a large peripheral region of the lens may receive incident light with large incident angles or from a large field of view. Therefore, the efficiency of fast PBP lens may be low at a larger viewing aperture (e.g., the peripheral regions). The low efficiencies at larger viewing apertures may lead to brightness drop and/or image ghosts.

FIG. 10B illustrates the diffraction of light from different fields of view by an example of a PBP lens 1020 with uniform liquid crystal coating (e.g., with uniform twist angle along the z direction). FIG. 10B shows that, for paraxial light 1022, PBP lens 1020 may have a phase delay close to about π, and thus may have a high diffraction efficiency, such that the undiffracted portion (leakage) may be very low. However, for off-axis light 1024, PBP lens 1020 may have a phase delay different from π, and thus may have a lower diffraction efficiency, such that the undiffracted portion (leakage) may be higher.

FIG. 10C includes a curve 1030 illustrating an example of the diffraction efficiency of a PBP lens including liquid crystals with uniform liquid crystal coating (e.g., with a uniform twist angle along the z direction) as a function of the incident angle of the incident light. In the illustrated example, the PBP lens may have a phase delay about π for surface-normal incident light (with an incident angle about 0°), and thus may have a high diffraction efficiency for the incident light. As the incident angle or field of view increases with the increase of the viewing aperture, the phase delay may change and thus the diffraction efficiency may decrease as the viewing aperture increases. As described above, the low efficiencies at larger viewing apertures may lead to brightness drop and/or image ghosts. It is noted that curve 1030 is for illustration purposes only, and may not necessarily represent the diffraction efficiency of all PBP lenses as a function of the incident angle of the incident light.

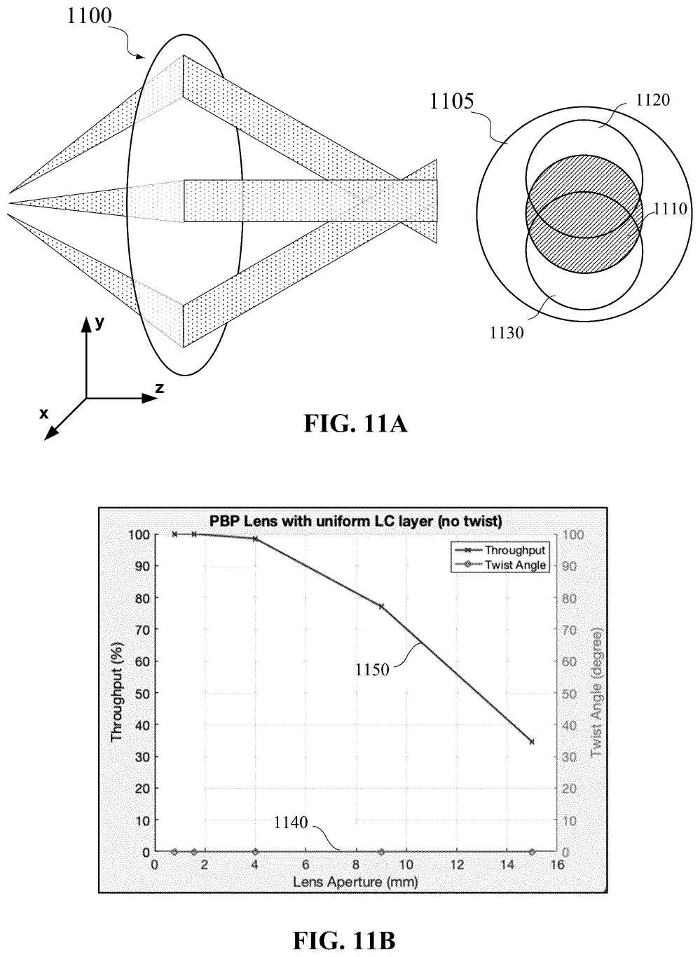

FIG. 11A illustrates the diffraction of light from different fields of view (or incident angles) by a PBP lens 1100 having a uniform liquid crystal coating (e.g., with a uniform twist angle along the z direction). The uniform liquid crystal coating of PBP lens 1100 may be designed to achieve high diffraction efficiencies for paraxial light (or light with small incident angles), and thus PBP lens 1100 may have lower performance for incident light having large incident angles, due to the limited angular bandwidth of PBP lens 1100 (e.g., caused by the lens design and/or material properties, such as the birefringence of the liquid crystal material). For example, the field of view of PBP lens 1100 may be shown by a circle 1105 in a polar plot in FIG. 11A, while the angular bandwidth of PBP lens 1100 may be indicated by a circle 1110, where incident light with incident angles within circle 1110 may be diffracted by PBP lens 1100 at high efficiencies, whereas incident light with incident angles outside of circle 1110 may be diffracted by PBP lens 1100 at low efficiencies.

As illustrated, light from an image source may be incident on different positions of the viewing aperture of PBP lens 1100 at different angles. Thus, the angle of interest (AOI) at different positions of the viewing aperture of PBP lens 1100 may be different. For example, at a center region of PBP lens 1100, the AOI may be small (e.g., within circle 1110), and thus the center region of PBP lens 1100 may have high performance for its AOL. However, at off-centered regions, the AOI may be large and may not be within the angular bandwidth of PBP lens 1100. For example, a circle 1120 in FIG. 11A shows the AOI at a lower region of PBP lens 1100, where circle 1120 may have a portion outside of the angular bandwidth of PBP lens 1100 indicated by circle 1110. Similarly, a circle 1130 in FIG. 11A shows the AOI at an upper region of PBP lens 1100, where circle 1130 may have a portion outside of the angular bandwidth of PBP lens 1100 indicated by circle 1110. Since PBP lens 1100 may have the same limited angular bandwidth (shown by circle 1110) at all regions due to the uniform liquid crystal coating, PBP lens 1100 may have a low performance for incident light with large incident angles (outside the angular bandwidth indicated by circle 1110). Therefore, the off-centered regions of PBP lens 1100 may not have high performance for the respective AOIs at the off-centered regions.

FIG. 11B illustrates the performance of an example of a PBP lens including liquid crystals with a uniform twist angle (e.g., about 0°) as a function of the location on the PBP lens. In the illustrated example, a curve 1140 shows that the twist angles of the liquid crystals at different locations of the PBP lens may all be about 0°. A curve 1150 shows the throughout (e.g., diffraction efficiency or polarization conversion efficiency) of the PBP lens at different locations on the PBP lens. Curve 1150 shows that the efficiency at a location of the PBP lens be a function of the distance of the location from the center of the PBP lens, since the AOIs at different locations of the PBP lens may be different. As the distance of the location from the center of the PBP lens increases, the throughput may decrease. In the illustrated example, the throughput of the PBP lens for a single wavelength may be close to about 100% at regions within about 5 mm from the center the PBP lens, but may be less than 80% in a zone about 9 mm from the center the PBP lens, and below about 40% in a zone about 15 mm from the center the PBP lens. As described above, the low efficiencies at larger viewing apertures may lead to brightness drop and/or image ghosts.

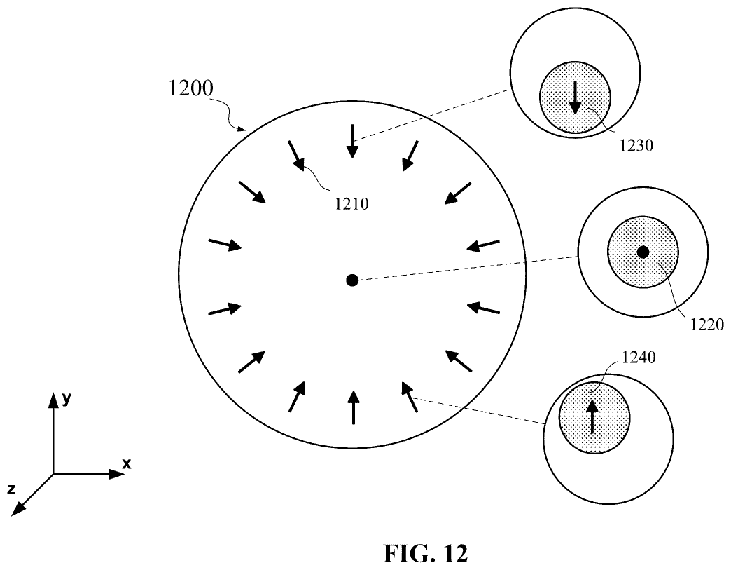

FIG. 12 illustrates the angles of interest (e.g., view angles) at different regions of an example of a PBP lens 1200. Arrows 1210 in FIG. 12 illustrate the viewing angle directions (angles of interest) of the chief rays at different locations of the viewing aperture of PBP lens 1200. A circle 1220 in a polar plot shows the AOI in a center region of the viewing aperture of PBP lens 1200, a circle 1230 in a polar plot shows the AOI in an upper region of the viewing aperture of PBP lens 1200, and a circle 1240 in a polar plot shows the AOI in a lower region of the viewing aperture of PBP lens 1200. FIG. 12 shows that the AOIs at different locations of PBP lens 1200 may be different. Therefore, PBP lens 1200 may need to have different angular bandwidths at different regions in order to optimize the diffraction efficiencies at different locations of PBP lens 1200 for incident light within the respective AOIs.

According to certain embodiments, to improve the performance of a fast PBP lens at different viewing apertures with different angles of interest, the PBP device may be made to have spatially variable PBP structures that may be designed according to the angle of interest (AOI) at each zone of the viewing aperture. For example, the PBP lens may have spatially variable LC twist angles (and/or thicknesses) across its aperture, where the spatially variable LC twist angles may cause the phase delay of the PBP device to vary spatially as well. The LC twist angle at a position of the PBP lens may be selected to achieve the desired phase delay (e.g., about π) and hence high diffraction efficiency for incident light from an AOI of the position.

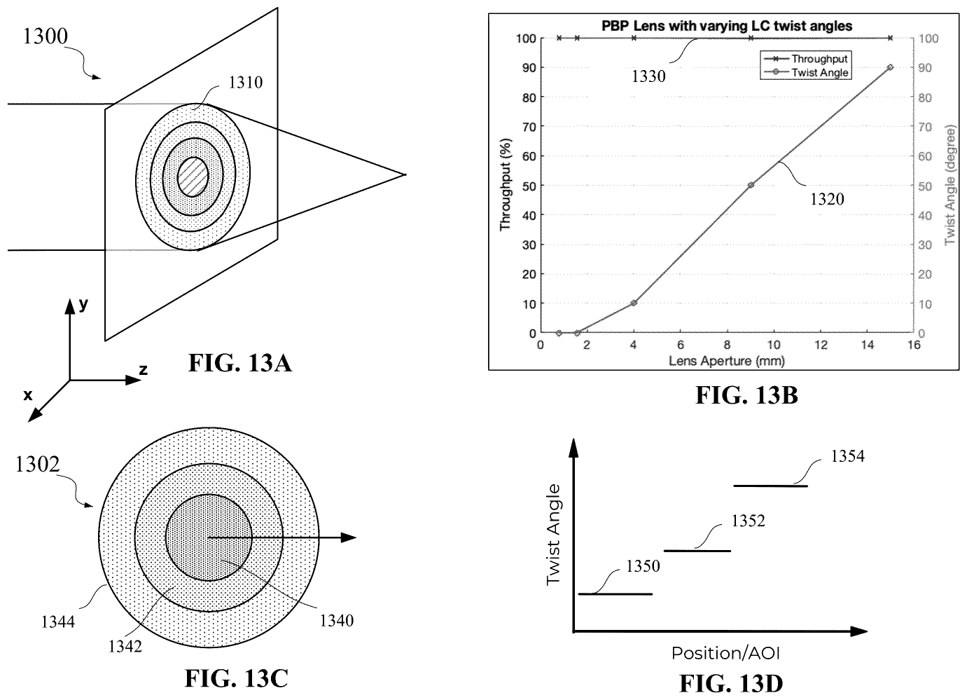

FIG. 13A illustrates an example of a PBP lens 1300 including liquid crystals with spatially varying twist angles according to certain embodiments. In the illustrated example, PBP lens 1300 may include multiple zones 1310 (e.g., circular or ring-shaped zones), where the liquid crystal twist angles (along the z direction) in different zones 1310 may be different. Therefore, the phase delays at different zones 1310 may be different and may be optimized for incident light with incident angles matching the respective AOIs for the zones.

FIG. 13B illustrates the performance of an example of a PBP lens (e.g., PBP lens 1300) including liquid crystals with spatially varying twist angles according to certain embodiments. The LC twist angle may vary as a function of the position on the PBP lens (and the AOI at the position of the PBP lens) as shown by a curve 1320. As show in FIG. 13B, at locations with different distances from the center of the PBP lens, the LC twist angle may be different (e.g., increasing with the increase in the distance from the center of the PBP lens) and may be selected to achieve better throughput (e.g., diffraction efficiency or polarization conversion efficiency). In the illustrated example, to achieve close to about 100% throughput throughout the aperture of the PBP lens as shown by a curve 1330, the LC twist angle may be about 0° in regions within less than about 2 mm from the center, about 10° in regions at about 4 mm from the center, about 50° in regions at about 9 mm from the center, and about 90° in regions about 15 mm from the center.

FIG. 13C illustrates an example of a PBP lens 1302 including liquid crystals with spatially varying twist angles according to certain embodiments. FIG. 13D illustrates the LC twist angles at different positions (zones) of PBP lens 1302 of FIG. 13C according to certain embodiments. PBP lens 1302 may be an example of PBP lens 1300. In the illustrated example, PBP lens 1302 may include 3 zones 1340, 1342, and 1344. Zones 1340, 1342, and 1344 may be at different positions on PBP lens 1302, and may have different AOIs. The twist angles of the liquid crystals in zones 1340, 1342, and 1344 may be shown by lines 1350, 1352, and 1354, respectively, in order to achieve better performance in zones 1340, 1342, and 1344. In the circular shaped center zone 1340, the LC twist angle may be small, and the pitch of the PBP lens in zone 1340 may be between about 5 μm to about 100 μm. In the ring-shaped zone 1342, the LC twist angle may be larger, and the pitch of the PBP lens in zone 1342 may be between about 2 μm to about 5 μm. In the ring-shaped zone 1344, the LC twist angle may be even larger, and the pitch of the PBP lens in zone 1344 may be between about 0.6 μm to about 2 μm.

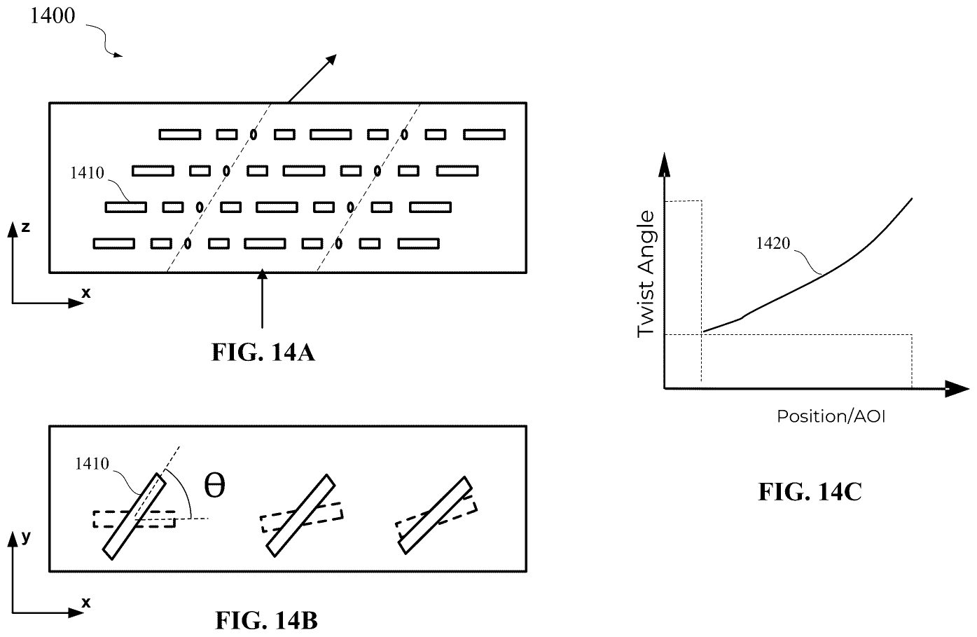

FIG. 14A is a side view of an example of a PBP lens 1400 including liquid crystals with spatially varying twist angles according to certain embodiments. FIG. 14B is a top view of the example of PBP lens 1400 of FIG. 14A. Light may propagate in substantially the z direction. As illustrated, liquid crystal molecules 1410 in PBP lens 1400 may rotate both in the x-y plane (e.g., according to a pattern for a PBP lens as shown in FIGS. 8A and 8B) and along the z direction. The total twist angle θ of liquid crystal molecules 1410 along the z direction may be different at different x-y locations.

FIG. 14C illustrates an example of the LC twist angle variations at different positions of PBP lens 1400 of FIG. 14A according to certain embodiments. As described above, at different positions of the PBP lens, the AOIs may be different. To improve the performance of the PBP lens for the different respective AOIs at different positions, the twist angles of the liquid crystal molecules along the z direction at different positions of the PBP lens may need to be different, as illustrated by a curve 1420 in FIG. 14C.

As described above, there may be several different ways to achieve the nonuniform phase delay across the aperture of a PBP lens, such as by changing the twist angle and/or the thickness of the LC materials across the aperture of the PBP lens. The LC materials may include a chiral molecule in the LC host. The chiral molecule may act on the host to create the rotation in the LC director. The efficiency of the LC materials (e.g., including the chiral molecule) in inducing the twisting of the LC molecules is referred to as the (helical) twisting power (P), which may be controlled by the electromagnetic field, temperature, and concentration of the doping materials (e.g., the chiral molecule). For example, in some embodiments, the spatially variable twist angles may be achieved by depositing different mixtures of a chiral LC material and a non-chiral LC material (or another chiral LC material with a different twisting power) at different zones, such that the materials at different zones may have different twisting power. In some embodiments, the spatially variable twist angles may be achieved by curing a LC material layer using gradient or gray-scale UV light to promote different diffusion of the chiral agents into different regions of the LC material layer. In some embodiments, the spatially variable twisting angles may be achieved by performing multiple cycles of uniform LC material layer deposition, UV curing, and lithographic patterning to effectively achieve different materials, different exposure doses, and/or different material thicknesses at different zones of a PBP lens. In some embodiments, the spatially variable twist angles may be achieved by fabricating multiple patterned layers of LC materials and stacking the multiple patterned layers together. In some embodiments, the spatially variable twist angles may be achieved by depositing (e.g., inkjet printing) different LC materials on different regions of a bare substrate, imprinting the LC materials using a nanoimprinting mold or stamp with designed patterns, and curing the LC materials.

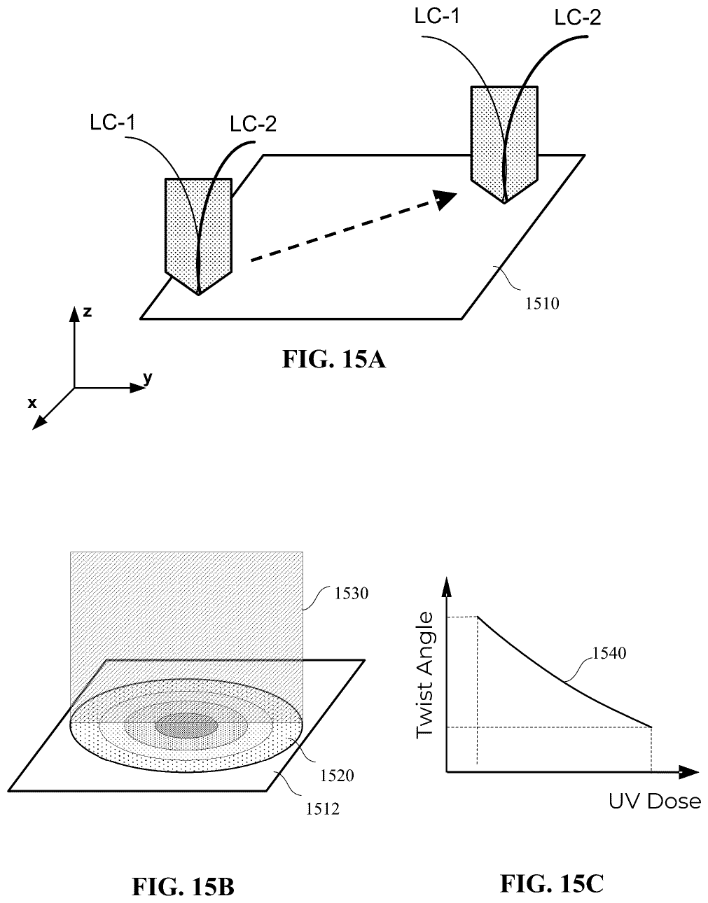

FIG. 15A illustrates an example of a method of fabricating a PBP lens with spatially varying LC twist angles according to certain embodiments. In the illustrated example, a substrate 1510 including an alignment pattern formed thereon as described above may be used as the substrate for the PBP lens. Different mixtures of a chiral LC material (e.g., LC-1) and a non-chiral LC material (e.g., LC-2) (or another chiral LC material with a different twisting power) may be deposited at different locations of substrate 1510. Therefore, the materials at different locations of substrate 1510 may have different twisting power and the same or different thicknesses. Upon exposure to, for example, UV or blue light, the LC molecules at different locations of substrate 1510 may have different twisting angles due to the different twisting power.

FIG. 15B illustrates another example of a method of fabricating a PBP lens with spatially varying LC twist angles according to certain embodiments. In the illustrated example, a uniform layer of a chiral LC material 1520 with the same LC material and/or the same thickness may be deposited on a substrate 1512 that has an alignment pattern formed thereon as described above. The uniform layer of chiral LC material 1520 may be cured using nonuniform doses of UV light at different regions of the LC material layer to promote different diffusion of chiral agents in the different regions of the LC material layer, thereby inducing different LC twisting angles at the different regions. For example, in some embodiments, a UV light beam 1530 with a non-uniform beam intensity profile may be used to radiate the uniform layer of chiral LC material 1520. In some embodiments, a UV light beam with a uniform beam intensity profile may be used to radiate the uniform layer of chiral LC material 1520, and different regions of the uniform layer of chiral LC material 1520 may be exposed to the UV light beam for different time durations.

FIG. 15C illustrates an example of a relationship between the LC twist angle and the UV light exposure dose for fabricating a PBP lens with spatially varying LC twist angles according to the method of FIG. 15B. FIG. 15C is for illustration purpose only and may not reflect the relationship between the LC twist angle and the UV light exposure dose for a specific chiral LC material. A curve 1540 in FIG. 15C shows an example of a relationship between the LC twist angle and the UV light exposure dose. To achieve a desired LC twist angle at a location of substrate 1512, the UV dose for exposing the uniform layer of chiral LC material 1520 at the location may be determined based on the relationship (e.g., shown by curve 1540), and the corresponding region of the uniform layer of chiral LC material 1520 may be exposed by UV light with the desired dose.

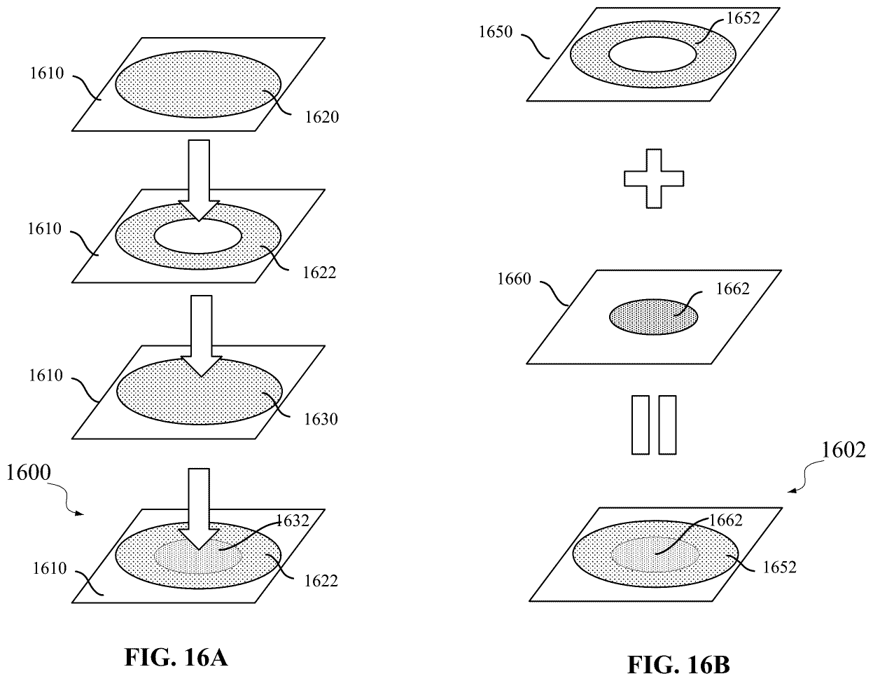

FIG. 16A illustrates another example of a method of fabricating a PBP lens with spatially varying LC twist angles according to certain embodiments. As illustrate, a uniform coating layer 1620 including liquid crystal molecules and chiral dopants may be coated on a substrate 1610, for example, by spin coating or spray coating. Substrate 1610 may include an alignment pattern formed thereon. The alignment pattern may have different pitches at different regions, and may have the pattern for a lens as shown in, for example, FIGS. 8A and 8B. The uniform coating layer may be cured using UV light, and/or may be patterned using lithography techniques to remove certain portions (e.g., a center region) of the uniform coating layer 1620 after or before the curing, to form a zone 1622 of a PBP lens on substrate 1610. Another coating layer 1630 include liquid crystal molecules and chiral dopants may be coated on substrate 1610 and zone 1622. Coating layer 1630 may be cured using UV light, and/or may be patterned using lithography techniques to remove certain portions (e.g., the peripheral region) of the coating layer 1630 after or before the curing to form a zone 1632 of the PBP lens. Multiple cycles of the coating, curing, and/or patterning processes described above may be performed to form a PBP lens 1600 that includes multiple LC material zones formed on multiple regions of substrate 1610. Different LC material zones may have different grating pitches and different desired twist angles caused by, for example, different material compositions, different thicknesses, and/or different exposure times at the multiple regions of substrate 1610.

FIG. 16B illustrates yet another example of a method of fabricating a PBP lens with spatially varying LC twist angles according to certain embodiments. In the illustrated example, a first LC material region 1652 may be formed on a first substrate 1650 by, for example, coating a uniform LC material layer on first substrate 1650, curing the uniform LC material layer using UV light, and patterning the uniform LC material layer by lithographic patterning after or before the curing, as described above with respect to FIG. 16A. Similarly, a second LC material region 1662 may be formed on a second substrate 1660 by, for example, coating a uniform LC material layer on second substrate 1660, curing the uniform LC material layer using UV light, and patterning the uniform LC material layer by lithographic patterning after or before the curing, as described above with respect to FIG. 16A. Other LC material regions may be formed on other substrates in a similar manner. The different LC material regions may have different material compositions, different thicknesses, and/or different exposure times, and thus may have different desired LC twist angles. The multiple substrates with multiple LC material regions formed thereon may be stacked and/or bonded to form a PBP lens 1602 that includes multiple zones with non-uniform designs (e.g., different LC twist angles and grating pitches).

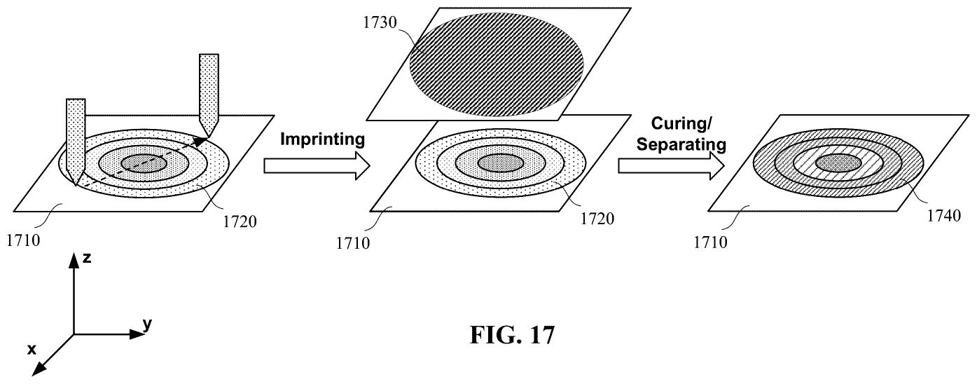

FIG. 17 illustrates an example of a method of fabricating a PBP lens with spatially varying LC twist angles using nano-imprinting techniques according to certain embodiments. In the illustrated example, an LC material layer 1720 may be formed on a substrate 1710 by, for example, inkjet printing or 3D printing. The substrate may be a bare substrate with no alignment pattern formed thereon. In some embodiments, substrate 1710 may be treated for degenerate LC alignment. In some embodiments, LC material layer 1720 may have different compositions in different zones as described above with respect to FIG. 15A. LC material layer 1720 may include, for example, liquid crystal molecules mixed with photocurable monomers or polymers to form polymerizable liquid crystal reactive mesogens. In some embodiments, LC material layer 1720 may include a photo-initiator, a chiral dopant, and/or a dichroic dye. As described above, in some embodiments, different mixtures of a chiral LC material and a non-chiral LC material (or another chiral LC material with a different twisting power) may be deposited on different zones of the substrate.

LC material layer 1720 may be nano-imprinted using a mold 1730 (or a stamp) with patterns formed thereon. The nano-imprint process may planarize LC material layer 1720 and form complementary patterns in LC material layer 1720. LC material layer 1720 may then be cured to cause the polymerization and fixing of liquid crystals in LC material layer 1720, thereby forming a PBP lens 1740 with desired patterns in multiple zones as shown in FIG. 17. After the curing of LC material layer 1720, mold 1730 and substrate 1710 may be separated or may not be separated. After the separation, PBP lens 1740 may be on substrate 1710 or on mold 1730. Nano-imprinting techniques may improve the yield and reduce the cost due to the relatively simple and quick processes. In one example, a master mold with patterns same as or similar to the desired patterns in an alignment layer may be made by, for example, two-photon polymerization-based direct-laser writing technique. A soft stamp, such as a transparent polymer dimethylsiloxane (PDMS) stamp, may be cast from the master mold. The soft stamp may be positioned on and pressed against LC material layer 1720, for example, using a roller, such that LC material layer 1720 may have the desired patterns formed therein. LC material layer 1720 may be cured by UV light, for example, through the transparent PDMS stamp or transparent substrate 1710, to initiate cross-linking polymerization reactions. In some embodiments, heat may be applied to LC material layer 1720 to facilitate the polymerization. After the curing, the soft stamp may be gradually delaminated from the cured LC material layer 1720, and the cured LC material layer 1720 may include the desired patterns formed therein to form PBP lens 1740.

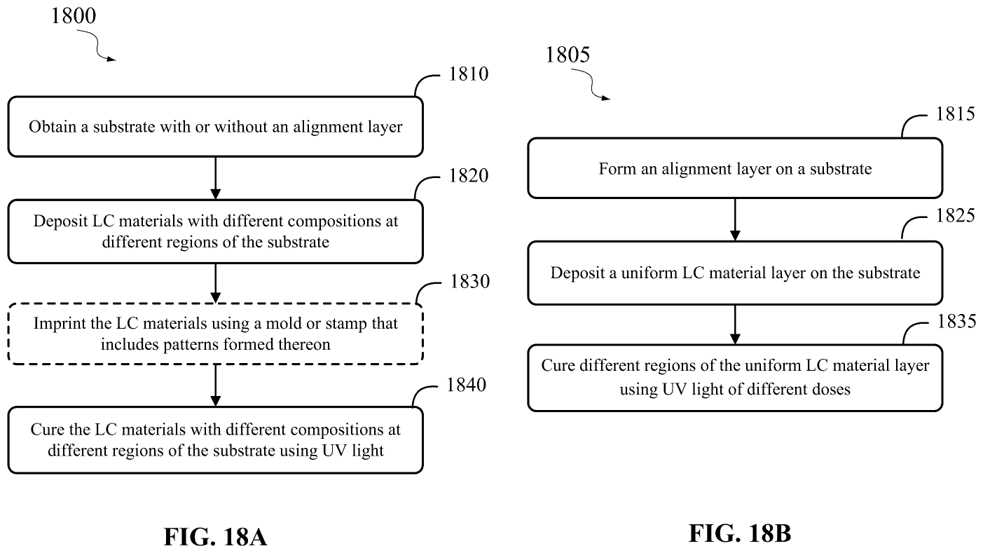

FIG. 18A includes a flowchart 1800 illustrating an example of a process of fabricating a PBP lens with spatially varying LC structures according to certain embodiments. It is noted that the operations illustrated in FIG. 18A provide particular processes for fabricating PBP lenses as shown in, for example, FIG. 15A or 17. Other sequences of operations can also be performed according to alternative embodiments. For example, alternative embodiments may perform the operation in a different order. Moreover, the individual operations illustrated in FIG. 18A can include multiple sub-operations that can be performed in various sequences as appropriate for the individual operation. Furthermore, some operations can be added or removed depending on the particular applications. In some implementations, two or more operations may be performed in parallel. One of ordinary skill in the art would recognize many variations, modifications, and alternatives.

Operations at block 1810 may include obtaining a substrate with or without an alignment layer formed thereon. In some embodiments, an alignment layer may be formed on the substrate (e.g., a glass substrate). As described above, the alignment layer may be formed on the substrate by, for example, polarization interference patterning, direct laser writing patterning, imprint lithography, and the like. Operations at block 1820 may include depositing LC materials with different compositions at different regions of the substrate. For example, as described above with respect to FIG. 15A, different mixtures of a chiral LC material (e.g., including liquid crystal molecules, monomers or polymers, and a chiral agent dopant) and a non-chiral LC material (or another chiral LC material with a different twisting power) may be deposited at different regions or zones of the substrate. Therefore, the materials at different regions of the substrate may have different twisting power. Upon exposure to, for example, UV or blue light, the LC molecules at different regions of the substrate may have different twisting angles due to the different twisting power. Optionally, at block 1830, if the substrate is a bare substrate with no patterns formed there, the LC materials may be imprinted using a mold or stamp that includes patterns formed thereon as described above with respect to FIG. 17. Operations at block 1840 may include curing the LC materials with different compositions at different regions of the substrate using a UV light beam with a uniform beam intensity profile. The curing may polymerize photocurable monomers or cross-link polymers in the liquid crystal materials to form crosslinked polymers that may stabilize the liquid crystal molecules. In some embodiments where the LC materials are imprinted, the mold or stamp for the imprinting may be separated from the substrate.

FIG. 18B includes a flowchart 1805 illustrating an example of a process of fabricating a PBP lens with spatially varying LC twist angles according to certain embodiments. It is noted that the operations illustrated in FIG. 18B provide particular processes for fabricating PBP lenses as shown in, for example, FIG. 15B. Other sequences of operations can also be performed according to alternative embodiments, such as operations shown in FIGS. 16A and 16B.

Operations at block 1815 may include forming an alignment layer on a substrate (e.g., a glass substrate). As described above, the alignment layer may be formed on the substrate by, for example, polarization interference patterning, direct laser writing patterning, imprint lithography, and the like. Operations at block 1825 may include depositing a uniform LC material layer on the substrate. As described above, the uniform LC material layer may include, for example, liquid crystal molecules, monomers or polymers, a chiral agent dopant, a photo-initiator, a dichroic dye, or a combination thereof. At block 1835, the uniform LC material layer may be cured using UV light, where different regions of the uniform LC material layer may be cured using UV light of different doses to cause different twist angles in the different regions. For example, as described above with respect to FIG. 15B, a UV light beam with a non-uniform beam intensity profile may be used to radiate the uniform LC material layer, or a UV light beam with a uniform beam intensity profile may be used to radiate different regions of the uniform LC material layer for different time durations.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A Pancharatnam-Berry phase (PBP) lens comprising:
a substrate; and
one or more liquid crystal material layers on the substrate and including a plurality of zones at different distances from a center of the PBP lens, wherein different zones of the plurality of zones of the one or more liquid crystal material layers are characterized by different liquid crystal twist angles along a surface-normal direction of the substrate.

2. The PBP lens of claim 1, wherein the PBP lens is characterized by an f-number less than 1.

3. The PBP lens of claim 1, wherein a first liquid crystal twist angle of a first zone of the plurality of zones of the one or more liquid crystal material layers closer to the center of the PBP lens than a second zone of the plurality of zones of the one or more liquid crystal material layers is smaller than a second liquid crystal twist angle of the second zone of the plurality of zones of the one or more liquid crystal material layers.

4. The PBP lens of claim 1, wherein liquid crystal twist angles of the plurality of zones of the one or more liquid crystal material layers decrease as distances of the plurality of zones from the center of the PBP lens increase.

5. The PBP lens of claim 1, wherein the different liquid crystal twist angles of the different zones of the plurality of zones of the liquid crystal material layer are between 0° and 90°.

6. The PBP lens of claim 1, wherein phase delays of two or more zones of the plurality of the zones of the one or more liquid crystal material layers are different from π for surface-normal incident light.

7. The PBP lens of claim 1, wherein:
the substrate includes an alignment layer with an alignment pattern formed therein; and
liquid crystal molecules in the one or more liquid crystal material layers are arranged according to the alignment pattern in a plane parallel to the substrate.

8. The PBP lens of claim 1, wherein the different zones of the plurality of zones of the one or more liquid crystal material layers are characterized by different material compositions, different thicknesses, or both.

9. The PBP lens of claim 8, wherein the different material compositions include different concentrations of a chiral dopant.

10. The PBP lens of claim 1, wherein two or more zones of the plurality of zones of the one or more liquid crystal material layers are formed on two or more respective substrates.

11. The PBP lens of claim 1, wherein a pitch of a first zone of the plurality of zones of the one or more liquid crystal material layers closer to the center of the PBP lens than a second zone of the plurality of zones of the one or more liquid crystal material layers is larger than a pitch of the second zone of the plurality of zones of the one or more liquid crystal material layers.

12. The PBP lens of claim 1, wherein an efficiency of the PBP lens at a peripheral region of the PBP lens is greater than 75% for light of a visible wavelength.

13. A near-eye display system comprising:
a display panel configured to generate display images; and
a Pancharatnam-Berry phase (PBP) lens configured to project the display images to an eye of a user of the near-eye display system, the PBP lens comprising:
a substrate; and
one or more liquid crystal material layers on the substrate and including a plurality of zones at different distances from a center of the PBP lens, wherein different zones of the plurality of zones of the one or more liquid crystal material layers are characterized by different liquid crystal twist angles along a surface-normal direction of the substrate.

14. The near-eye display system of claim 13, wherein the PBP lens is characterized by an f-number less than 1 and an efficiency at a peripheral region of the PBP lens greater than 75% for light of a visible wavelength.

15. The near-eye display system of claim 13, wherein liquid crystal twist angles of the plurality of zones of the one or more liquid crystal material layers decrease as distances of the plurality of zones from the center of the PBP lens increase.

16. The near-eye display system of claim 13, wherein a pitch of a first zone of the plurality of zones of the one or more liquid crystal material layers closer to the center of the PBP lens than a second zone of the plurality of zones of the one or more liquid crystal material layers is larger than a pitch of the second zone of the plurality of zones of the one or more liquid crystal material layers.

17. The near-eye display system of claim 13, wherein:
the substrate includes an alignment layer with an alignment pattern formed therein; and
liquid crystal molecules in the one or more liquid crystal material layers are arranged according to the alignment pattern in a plane parallel to the substrate.

18. The near-eye display system of claim 13, wherein the different zones of the plurality of zones of the one or more liquid crystal material layers are characterized by different material compositions that include different concentrations of a chiral dopant.

19. The near-eye display system of claim 13, wherein the plurality of zones of the one or more liquid crystal material layers is formed on two or more substrates.

20. The near-eye display system of claim 13, further comprising a circular polarizer between the display panel and the PBP lens.
